(19) United States
(12) Patent Application Publication
(10) Pub. No.: US 2008/0313940 A1
(43) Pub. Date: Dec. 25, 2008

(54) Light up pen with advertisements

(75) Inventor: Wei-Chin Chen, Taipei (TW)

Correspondence Address: Joe McKinney Muncy, PO Box 1364, Fairfax, VA, 22038-1364, US

(73) Assignee: SPEADA INDUSTRIAL CO., LTD.

(21) Appl. No.: 11/819,113

(22) Filed: Jun. 25, 2007

(51) Int. Cl. G06Q 30/00; B43K 7/00; G09F 23/00

(52) U.S. Cl. 40/334

(57) ABSTRACT

A light up pen with advertisements, which is constructed by a hollow upper pen tube connected with a lower pen tube with refill accommodated thereinside. A first tube of the upper pen tube has a light emitting device mounted therein and the light emitting device includes a light emitting unit, a power unit and a control unit. The second tube has a partition mounted therein for defining plural accommodating spaces. The light emitting unit is extended into the accommodation space corresponding thereto, and through the power unit supplying power to the light emitting unit and the control unit controlling the illumination of the light emitting unit, the characters or patterns on the slides can be revealed for achieving a great commercial effect.

### FIELD OF THE INVENTION

The present invention is related to a light up pen, and more particularly to a light up pen with commercial effect.

### BACKGROUND OF THE INVENTION

Generally, except audio or video broadcast, the advertisements also can be achieved in printing, such as handbills or magazines. The drawback of distributing handbill is that it can not be sure that people will read the contents after receiving the handbill. Usually, the handbill might be thrown away, and even people retain the handbill, the possibility of reviewing is quite low, so that this is not only wasting resources, but also not an optimum manner. Accordingly, an advertisement cooperating with usable object, such as facial tissues, pens or pens capable of hanging on neck, is developed, so as to increase the holding duration and also the commercial benefit. However, since the volume and surface area of the usable object are both small, the characters printed thereon must be shrunk, so that the commercial benefit is reduced.

Consequently, owing to the drawbacks described above, R.O.C. patent No. M286131 disclosed “pen with commercial effect” includes a hollow penholder with a refill, a roll-back device, and a commercial sheet. The penholder has a long slot opened on the body and extended in the longitudinal direction, and the writing head of the refill can be stretched out of the penholder through one end thereof. The roll-back device is installed in the penholder at the location corresponding to the position of the long slot and includes an axial tube and a spring, wherein the spring is connected between the axial tube and the penholder for providing the axial tube a torque. The commercial sheet, which is flexible, is fixedly connected to the axial tube through one edge thereof and coiled on the axial tube, so that it is installed in the penholder with the roll-back device, and the opposite edge to the fixed one is stretched out of the penholder through the long slot. Although, in this technology, the advertisement can be revealed on a larger page, the commercial sheet is rolled in the penholder and invisible, so that the advertisement might lose the effect if the owner doesn't notice.

Furthermore, R.O.C patent publication No. 457980, entitled “light up pen structure with commercial effect”, includes a front pen tube, a connecting tube and a rear pen tube. The connecting tube is connected at the rear end of the front tube and is made of transparent material, and after screen printing and etching, the connecting tube may have a transparent portion and a masking portion, wherein the transparent portion can be an advertisement pattern. The rear tube has a light emitting unit mounted therein which is composed of a circuit board, a button switch, a light emitting element and a battery set. When the user touches off the light emitting unit to illuminate, the transparent portion of the connecting tube may pervious to light, so as to reveal the advertisement pattern and achieve the commercial effect. However, this technology has the disadvantages that:

1. The connecting only can display one single advertisement and can not be separated into plural sections for multiple advertisements, and if there is the need to promote other advertisement, it will need another connecting tube, which might increase the cost.

2. Even though the connecting tube can be separated into plural sections for multiple advertisements, one single illumination still can not provide different colors of light, so that it might outcome an unsatisfied result.

3. The etching on the connecting tube may form a rough surface which actually may cause the dirt to accumulate, so that it might be easily damaged, which will influence the transparency.

Therefore, the conventional technologies need to be improved.

### SUMMARY OF THE INVENTION

The object of the present invention is to provide a light up pen with commercial effect, which is arrestive through a light up pen tube for achieving a commercial effect, and further, the structure of the pen tube is designed to have plural regions for installing advertisements and even for exchanging the advertisements, so as to provide a better variation.

For achieving the object described above, the present invention is related to a light up pen with advertisements, which is constructed by a hollow upper pen tube connected with a lower pen tube with refill accommodated thereinside. A first tube of the upper pen tube has a light emitting device mounted therein and the light emitting device includes a light emitting unit, a power unit and a control unit. A second tube has a partition mounted therein for defining plural accommodating spaces, wherein the partition has a holding portion extended from the end thereof connected with the second tube so as to hold at least two slides between the second tube and the holding portion. The second tube has a first combination portion and the partition correspondingly has a second combination portion, so as to make the first and the second combination portions combinable and separable. The light emitting unit is extended into the accommodation space corresponding thereto, and through the power unit supplying power to the light emitting unit and the control unit controlling the illumination of the light emitting unit, the characters or patterns on the slides can be revealed for achieving a great commercial effect.

1. The present invention utilizes partitions to divide the pen tube into plural regions, so that multiple advertisements can be presented on the pen tube simultaneously for satisfying the purposes of different products promotion.

2. Each advertisement has an independent light with different color, so that the advertisements can be distinguished from each other and the message can be expressed more clearly.

3. The slides are located between the second tube and the holding portion and can be exchanged for presenting different advertisements, so that the cost can be saved and the user can change the pattern according to different favors.

4. The second tube of the present invention employs smooth arc surface for replacing the rough surface caused from etching, so that the dirt will not accumulate to influence the perviousness of light.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows an appearance drawing of a light up pen with advertisement according to the present invention;

FIG. 2 shows a decomposition drawing of a light up pen with advertisement according to the present invention;

FIG. 3 shows a section drawing of a light up pen with advertisement according to the present invention;

FIG. 4 is a vertical view showing a second tube of a light up pen with advertisement according to the present invention; and

FIG. 5 is a vertical view showing a second tube of a light up pen with advertisement in a preferred embodiment according to the present invention.

### DESCRIPTION OF THE PREFERRED EMBODIMENT

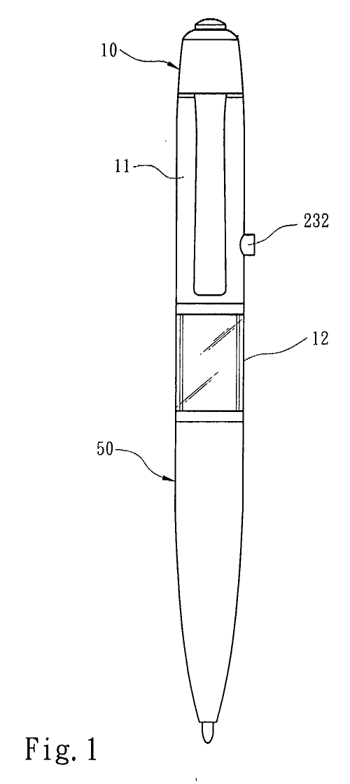

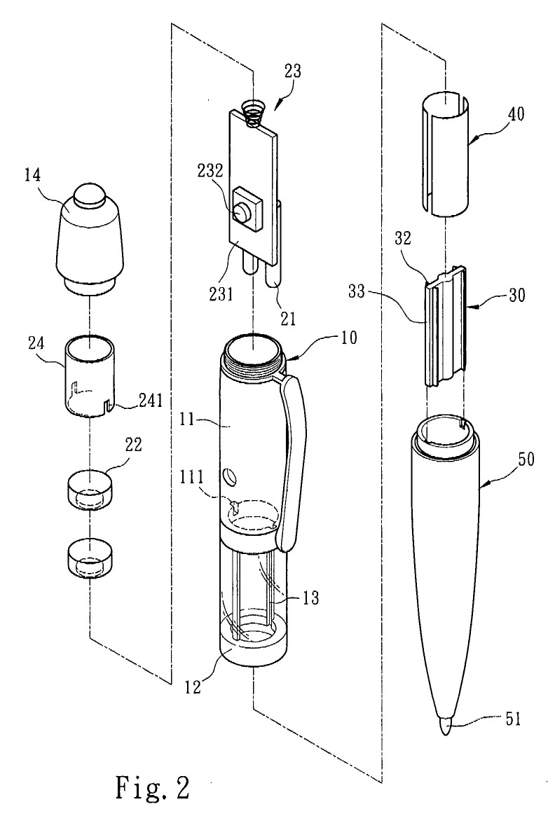

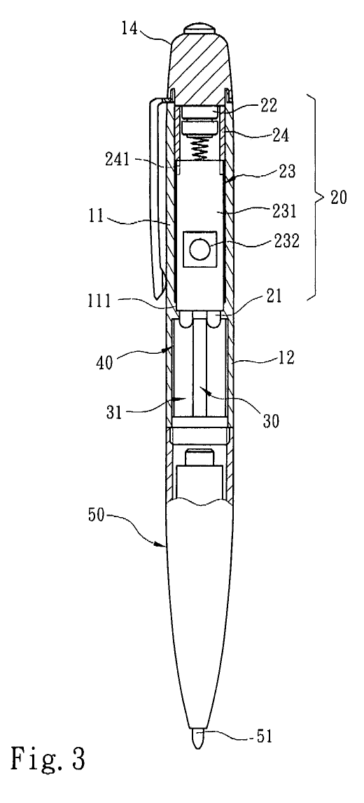

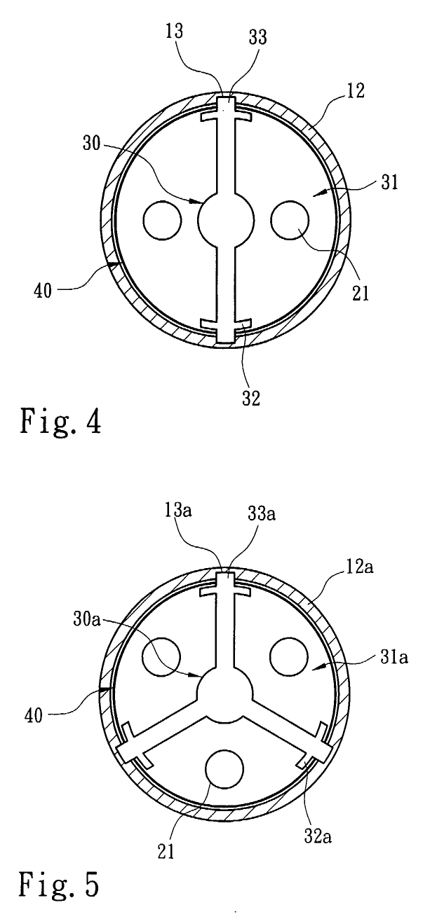

Please refer to FIGS. 1, 2 and 3 which respectively show the appearance, decomposition and sectional drawings of a light up pen with advertisements in the present invention and FIG. 4 which shows a vertical view of a second tube in the present invention. As shown, the present invention provides a light up pen with advertisements whose structure is constituted by a hollow upper pen tube 10 and a lower pen tube 50 with a refill accommodated therein. The upper pen tube 10 includes a first tube 11 and a transparent second tube 12. The first tube 11 has a light emitting device 20 mounted therein, wherein the light emitting device 20 includes a light emitting unit 21, a power unit 22 and a control unit 23. The light emitting unit 21 is fixedly mounted on the control unit 23 and both are plugged in a limit trough 111 inside the first tube 11, the power unit 22 (such as battery) is sleeved by an insulation sleeve 24 and is connected with the control unit 23, and the bottom of the insulation sleeve 24 has a gap 241 mounted thereon corresponding to the control unit 23, thereby through an engagement between the gap 241 and the control unit 23, the power unit 22 and the control unit 23 may have a stable electrical connection. The upper end of the first tube 11 further has a cover connected thereto for retaining the light emitting device 20 inside the first tube 11. The second tube 12 has an opaque partition 30 mounted therein for defining plural accommodating spaces 31, wherein the light emitting unit 21 is extended into a corresponding accommodating space 31, and the second tube 12 has a first combination portion 13 and the partition 30 has a second combination portion 33 corresponding thereto. In this embodiment, the first and the second combination portions 13, 33 can be, but not limited, a matched pair of indentation and protrusion, such that the first and the second combination portions 13, 33 can be combined together and also separated apart. Furthermore, the end of the partition 30 which is connected with the second tube 12 is extended to have a holding portion 32 and at least two slides 40 are positioned inside the second tube 12 and between the second tube 12 and the holding portion 32. Therefore, a light up pen with advertisements can be achieved.

In the present invention, the light emitting unit 21 can be a LED (light-emitting diode) and the slide 40 can be celluloid with characters. The control unit 23 may include a circuit board 231 and a switch 232 extended out of the first tube 11, wherein the switch 232 is fixedly mounted on the circuit board 231, so that when pressing the switch 232, a circuit loop is formed to make the light emitting unit 21 to illuminate, thereby the characters or patterns on the slides 40 can be revealed, and through the opaque partition 30, the light emitted by the light emitting units 21 in different accommodating spaces 31 will not interfere each other. Here, the circuit board 231 can control the illumination manner of the light emitting unit 21, such as constant lighting or sparkling, or can control the delay time for achieving a banner effect, so that the lighting method is not limited and can be altered according to different demands.

Please refer to FIG. 5, which is a vertical view showing the second tube in a preferred embodiment according to the present invention. As shown, in this embodiment, the partitions 30a, different from the above described embodiment, divide the second tube 12a into more than three accommodating spaces 31a, and the partition 30a can also has a holding portion 32a for holding the corresponding slide 40, so that through the light emitting unit 21 in corresponding accommodating spaces 31a illuminating, more than three kinds of advertisements can be revealed. Besides, the advertisements can be exchanged for better variation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light up pen with advertisements, comprising:
an upper pen tube, which is hollow and includes a first tube and a transparent second tube;
a lower pen tube, connected with the upper pen tube and having a refill accommodated thereinside;
a light emitting device, which is supported and mounted in the first tube and further includes a light emitting unit, a power unit and a control unit;
a partition, mounted in the second tube for defining plural accommodating spaces, and having a holding portion extended from the end thereof connected with the second tube; and
at least two slides, mounted inside the second tube and between the second tube and the holding portion,
wherein the second tube has a first combination portion and the partition correspondingly has a second combination portion, and the first and the second combination portions are combinable and separable, and the light emitting unit is extended into the accommodation space corresponding thereto.

2. The light up pen with advertisements as claimed in claim 1, wherein the first and the second combination portions are a matched pair of indentation and protrusion.

3. The light up pen with advertisements as claimed in claim 1, wherein the control unit comprises a circuit board and a switch, and the switch is fixedly mounted on the circuit board.

4. The light up pen with advertisements as claimed in claim 4, wherein the switch is extended out of the first tube.

5. The light up pen with advertisements as claimed in claim 1, wherein the first tube has a limit trough mounted inside the first tube.

6. The light up pen with advertisements as claimed in claim 1, wherein the power unit is sleeved by an insulation sleeve.

7. The light up pen with advertisements as claimed in claim 6, wherein the insulation sleeve has a gap corresponding to the control unit.

8. The light up pen with advertisements as claimed in claim 1, wherein the light emitting unit is a LED (light-emitting diode).

9. The light up pen with advertisements as claimed in claim 1, wherein the partition is made of opaque material.

10. The light up pen with advertisements as claimed in claim 1, wherein the slide is celluloid slides.
